(19) United States
(12) Patent Application Publication
(10) Pub. No.: US 2002/0131130 A1
(43) Pub. Date: Sep. 19, 2002

(54) Multi-tenant unit optical network

(75) Inventor: Gerald R. Clark, San Diego, CA (US)

Correspondence Address: FITCH EVEN TABIN AND FLANNERY, 120 SOUTH LA SALLE STREET, SUITE 1600, CHICAGO, IL, 60603-3406, US

(73) Assignee: LightPointe Communications, Inc.

(21) Appl. No.: 10/096,121

(22) Filed: Mar. 7, 2002

Related U.S. Application Data
(60) Provisional application No. 60/274,888, filed on Mar. 9, 2001.

(51) Int. Cl. H04B 10/00

(52) U.S. Cl. 359/172; 359/154

(57) ABSTRACT

The present invention provides a system and method for optical communication. The system includes a first rooftop transceiver mounted on a building and configured to transmit and receive optical signals over free space. A first passive optical deflector (POD) is mounted on the building and optically aligned with both the first rooftop transceiver and a first customer premise equipment (CPE), wherein the first POD is configured to receive a first optical signal from the first rooftop transceiver and redirect substantially all of the first optical signal to the first CPE providing a first optical communication path between the first rooftop transceiver and the first CPE. The first POD is further configured to receive a second optical signal from the first CPE and to redirect substantially all of the second optical signal to additional equipment extending the first communication path between the first CPE and the additional equipment.

### CROSS-REFERENCE TO RELATED APPLICATION

This application claims priority under 35 U.S.C. 119(e) to U.S. Provisional Patent Application No. 60/274,888, filed Mar. 9, 2001, of Gerald Clark, for MULTI-TENANT UNIT OPTICAL NETWORK, which U.S. Provisional Patent Application is hereby fully incorporated herein by reference.

### BACKGROUND OF THE INVENTION

1. Field of the Invention

The present invention relates generally to optical communication, and more specifically to free-space optical networking.

2. Discussion of the Related Art

For digital data communications, optical media offers many advantages compared to wired and RF media. Large amounts of information can be encoded into optical signals, and the optical signals are not subject to many of the interference and noise problems that adversely influence wired electrical communications and RF broadcasts. Furthermore, optical techniques are theoretically capable of encoding up to three orders of magnitude more information than can be practically encoded onto wired electrical or broadcast RF communications, thus offering the advantage of carrying much more information.

Fiber optics are the most prevalent type of conductors used to carry optical signals. An enormous amount of information can be transmitted over fiber optic conductors. A major disadvantage of fiber optic conductors, however, is that they must be physically installed. It would be highly desirable to have an optical delivery system that does not require stringing wires or fiber risers throughout a building to deliver data content to the end user. Thus, there is a need for a method, apparatus and/or system that overcomes these and other disadvantages.

### SUMMARY OF THE INVENTION

The present invention advantageously addresses the needs above as well as other needs by providing a system and method for communicating optical signals. In one embodiment, the invention can be characterized as a system for optical communications. The system includes a first rooftop transceiver mounted on a building and configured to transmit and receive optical signals over free space; and a first passive optical deflector (POD) mounted on the building and optically aligned with both the first rooftop transceiver and a first customer premise equipment (CPE), wherein the first POD is configured to receive a first optical signal from the first rooftop transceiver and redirect substantially all of the first optical signal to the first CPE providing a first optical communication path between the first rooftop transceiver and the first CPE, and wherein the first POD is configured to receive a second optical signal from the first CPE and redirect substantially all of the second optical signal to additional equipment extending the first communication path between the first CPE and the additional equipment.

In another embodiment, the invention can be characterized as a method for communicating. The method includes the steps of generating a first optical communication signal and transmitting the first optical signal at least in part over free space along an exterior of a building; redirecting the first optical signal to be received by a first customer premise equipment (CPE); the first CPE receiving the first optical signal; the first CPE re-transmitting at least a portion of the first optical signal; redirecting for a first instance the first optical signal re-transmitted by the first CPE over free space along the exterior of the building; redirecting for a second instance the first optical signal re-transmitted by the first CPE to be received by a second CPE; and the second CPE receiving the first optical signal.

In another embodiment, the invention can be characterized as a system for optical communications. The system includes a first premise equipment means for receiving and transmitting optical signals; a second premise equipment means for receiving and transmitting optical signals; an optical signal initiation means for transmitting a first optical signal across free space; a first redirecting means for receiving the first optical signal from the optical signal initiation means and for redirecting substantially all of the first optical signal to the first premise equipment means; a second redirecting means for receiving a second optical signal from the first premise equipment means and for redirecting substantially all of the second optical signal; and a third redirecting means for receiving the second optical signal from the second redirecting means and for redirecting substantially all of the second optical signal to the second premise equipment means. The system can additionally include a fourth redirecting means for receiving a third optical signal from the second redirecting means and for redirecting substantially all of the third optical signal; a fifth redirecting means for receiving the third optical signal from the fourth redirecting means and for redirecting substantially all of the fourth optical signal to the first premise equipment means; and a sixth redirecting means for receiving a fifth optical signal from the first premise equipment means and for redirecting substantially all of the fifth optical signal to the optical signal initiation means.

In another embodiment, the invention can be characterized as an apparatus for optical communications. The apparatus includes a body of optically transparent material; the body includes a first reflective element, wherein the first reflective element includes a first reflective surface and a second reflective surface; and the body includes a second reflective element, wherein the second reflective element includes a first reflective surface and a second reflective surface. The first and second reflective elements can be situated in the body so that a first optical signal reflected by the first reflective surface of the first reflective element and a second optical signal reflected by the second reflective surface of the second reflective element are substantially parallel.

In another embodiment, the invention can be characterized as a method of providing optical communication. The method includes the steps of: directing an optical signal to a passive optical deflector (POD) mounted on a window; and redirecting the optical signal with the POD so that the optical signal goes through the window.

In another embodiment, the invention can be characterized as a system for optical communications. The system includes a first optical transceiver configured to direct an optical signal adjacent to a surface of a window directed from the roof parallel to the building window, a passive optical deflector (POD) mounted on the window and configured to redirect the optical signal through the window, and a second optical transceiver configured to receive the optical signal redirected by the POD.

A better understanding of the features and advantages of the present invention will be obtained by reference to the following detailed description of the invention and accompanying drawings which set forth an illustrative embodiment in which the principles of the invention are utilized.

### BRIEF DESCRIPTION OF THE DRAWINGS

The above and other aspects, features and advantages of the present invention will be more apparent from the following more particular description thereof, presented in conjunction with the following drawings wherein:

FIG. 1 is a pictorial diagram illustrating a multi-tenant unit (MTU) optical network made in accordance with an embodiment of the present invention;

FIG. 2 is a simplified block diagram of one embodiment of the MTU network;

FIG. 3 is a simplified schematic diagram illustrating passive optical deflectors (PODs) and customer premise equipment (CPE) transceivers shown in FIGS. 1 and 2;

FIG. 4 is a simplified schematic diagram illustrating an active CPE transceiver made in accordance with an embodiment of the present invention;

FIG. 5 is a simplified schematic diagram illustrating passive CPE transceivers made in accordance with another embodiment of the present invention; and

FIGS. 6A and 6B depict a simplified schematic diagram illustrating an optical passive relay made in accordance with an embodiment of the present invention.

Corresponding reference characters indicate corresponding components throughout the several views of the drawings.

### DETAILED DESCRIPTION OF THE INVENTION

The following description is not to be taken in a limiting sense, but is made merely for the purpose of describing the general principles of the invention.

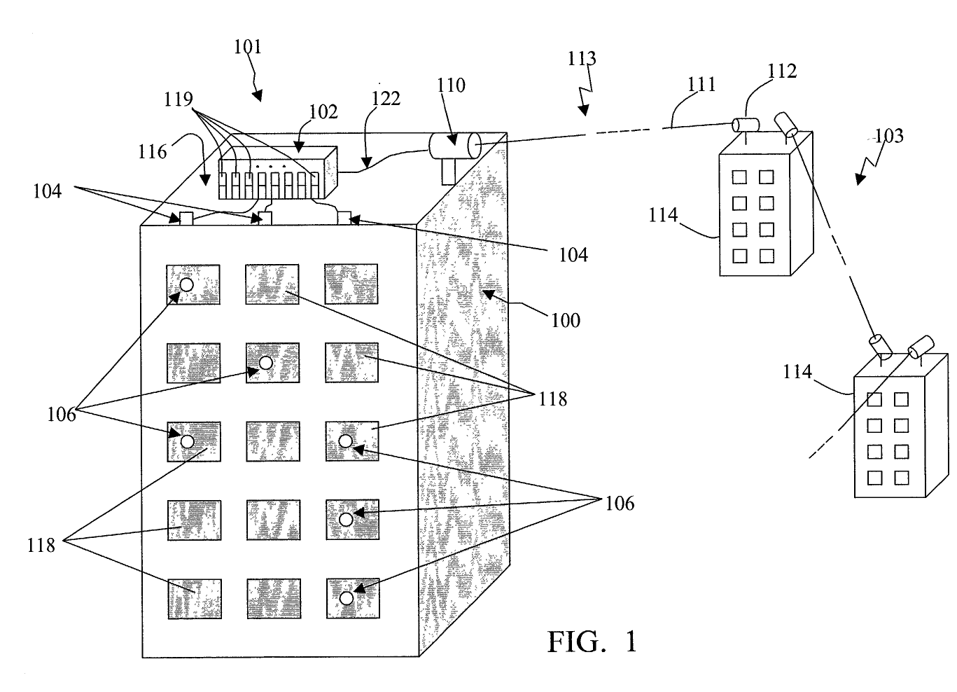

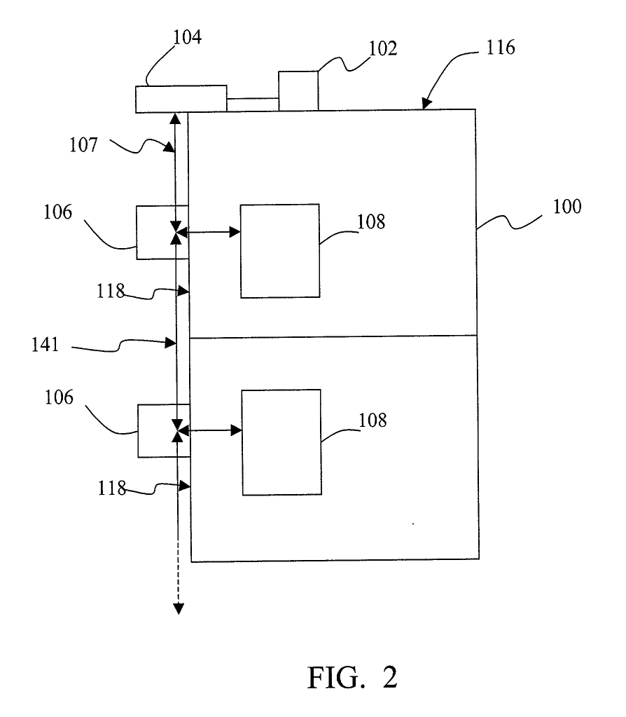

Referring to FIGS. 1 and 2, there is a simplified block diagram illustrating a building 100 that includes a multi-tenant unit (MTU) optical network 101 made in accordance with an embodiment of the present invention. The MTU optical network 101 may also be referred to as a multi-dwelling unit (MDU) optical network. In this embodiment, the MTU optical network 101 includes a customer distribution unit (CDU) 102 (alternatively referred to as a subscriber distribution unit (SDU) 102), one or more rooftop transceivers 104, one or more passive optical deflectors (PODs) 106, and customer premise equipment (CPE) 108.

The rooftop transceivers 104 preferably comprise optical transceivers mounted to the edge of the building rooftop 116, and couple with the CDU 102. The PODs 106 optically align with one or more rooftop transceivers 104 such that the rooftop transceivers 104 transmit and receive optical signals 107 to and from the PODs 106. The PODs further optically align with one or more CPEs 108. Typically, each POD aligns with one CPE 108. The PODs 106 receive the optical signals and direct or steer the optical signals to be received by the CPE 108, and receives optical signals from the CPEs and directs the optical signals to be received by the rooftop transceiver 104. The PODs 106 preferably direct substantially all of the optical signals to the CPE 108 or to the rooftop transceivers 104. By directing the optical signal, a POD 106 allows a building tenant to receive a high bandwidth optical signal without the need for wiring the building 100. In one embodiment, the PODs are mounted to the building windows 118, and redirect the optical signals through the building window 118 to be received by the CPE 108 and redirect the optical signals from the CPE to the rooftop transceiver.

In one embodiment, the MTU network 101 does not include rooftop transceivers, but includes alternate optical signal initiation means or sources. For example, the CDU 102 can couple directly to a CPE transceiver 108 that is the highest on the building 100. The CPE transceiver then initiates the optical communication signal to a POD 106, which in turn redirects the optical signal to one or more PODs and thus one or more other CPEs.

In one embodiment, the CDU 102 couples with an external communication network 103 that provides communication of data and information to and from the MTU network 101. The term data is used to describe any communication across the MTU network 101 and communication across the external network 103, including both digital and analog signals carrying information, audio, services, instructions, applications, processes and substantially any other data that can be communicated. The external communication network 103 can be phone lines, the internet, an intranet (e.g., a company network) and other such networks. The external communication network 103 can communicate information through electronic communication, optical communication over fiber optics, wireless communication, such as satellite, cellular, radio frequency and free-space optical communication, and other such communication schemes.

In one embodiment, the CDU 102 couples with a laser link head 110. The laser link head 110 provides communication with an external free-space optical communication network 103. The laser link head 110 may operate as an electro-optical device converting between optical and electrical, or operate all optically. For example, the laser link head 110 may provide strictly optical communication where the link head receives optical communication signals 111 over a free-space link 113 from a second link head 112 located at some distance, for example, located atop a second building 114. The link head 110 then forwards an optical signal across a communication cable 122 to be distributed through the MTU network 101. In this scenario the communication cable 122 would comprise a fiber optic cable or the like. Additionally, the link head receives optical signals through the communication cable 122 and transmits an optical signal 111 across the free-space link 113.

In one embodiment, the link head 110 receives optical signal and converts the signal to an electrical signal. The link head then converts the electrical signal to an optical signal and forwarded the optical signal across the fiber optic cable 122 to the CDU 102.

Alternatively, the link head 110 can provide electro-optical communication where the link head 110 receives an optical signal 111 from the second link head 112, converts the optical signal to an electric signal and forwards the signal over a communication cable 122 to be distributed through the MTU network 101. In this scenario the communication cable 122 would comprise an electric transmission line or the like. Additionally, the link head receives electrical signals through the communication cable 122, converts the electrical signal to an optical signal and transmits the optical signal 111 across one or more free-space links 113.

In one embodiment, the MTU network 101 couples with the external optical network 103 from the rooftop through the optical transceiver link head 110 to the CDU 102. As such, the customers are able to communication both within the MTU network 101 and with the external network 103 (e.g., phone lines coupled throughout the world). Communication received from the external network 103 is sent to the CDU 102 where the CDU directs the signal to an appropriate rooftop transceiver 104. In one embodiment, the CDU 102 includes routing capabilities to determine which of the plurality of rooftop transceiver 104a-c are to receive the signal. Alternatively, the CDU distributes or routes the signal to each rooftop transceiver and each rooftop transceiver forwards the signal to be received and processed by the appropriate destination CPE.

Once routing is determined, the CDU 102 sends the signal to one or more of the rooftop optical transceivers 104a-c. The rooftop optical transceiver 104 forwards the signal to one or more PODs 106. The signal can be sent from the CDU to the rooftop transceiver 104 as an optical signal over a fiber optic cable or as an electrical signal through a transmission line where the rooftop transceiver converts the electrical signal into an optical signal.

The rooftop transceiver 104 generates an optical signal and transmits the optical signal 107 over free space, typically along the exterior of the building 100. The rooftop transceiver 104 directs the optical signal 107 to impinge on one or more PODs 106. The POD 106 redirects the optical signal to a customer, for example, through the customer's (or tenant's) premise window 118. The transmitted signal 107 from the rooftop transceiver 104 typically spans a sufficient distance to reach the first POD 106. By way of example, this range can be as far as 300 meters or more, limited only by the height of the building and the precision of the transmission source (e.g., a laser) of the rooftop transceiver 104. Typically, the optical signal 107 is generated through a laser (not shown). The beam divergence, wavelength, and signal power are configurable parameters for the MTU system 101.

The POD 106 receives the optical signal 107 and redirects the signal through the customer premise window 118, to be received by the CPE 108. Advantageously, the optical delivery system provided by the MTU optical network 101 of the present invention does not require installing or stringing electrical wires, fiber optic cable or fiber risers throughout the building to deliver data to the end user, e.g., the customer.

In one embodiment, the CDU 102 is positioned on the rooftop 116 of the building 100 and constructed to operate in all weather conditions. Alternatively, the CDU 102 may be co-located with other indoor network equipment. For example, the CDU 102 may be located within the building 100 near routing/switching equipment. In the illustrated embodiment, the CDU 102 includes eight optical transceiver interfaces 119, but it should be well understood that any number of interfaces may be included. The interfaces 119 couple with the rooftop transceiver 104, and transmit and receive signals to and from the rooftop transceivers 104.

The CDU 102 may include an electrical data transceiver source or a passive optical network (PON) data transceiver source. For the PON scenario the rooftop transceivers 104 may be optically coupled to the optical transceiver interfaces 119 of the CDU 102. For example, the rooftop transceivers 104 may be fed by single or multi-mode fiber 120 from the CDU 102, which may operate at substantially any bit rate appropriate for the application. Similarly, the CDU 102 may be fed by single or multi-mode fiber 122 from the laser link head 110, again operating at various bit rates. In a scenario where the CDU 102 comprises an electrical data transceiver source, electrical signals from the layer 2/3 device are converted to optical signals through the rooftop transceivers 104.

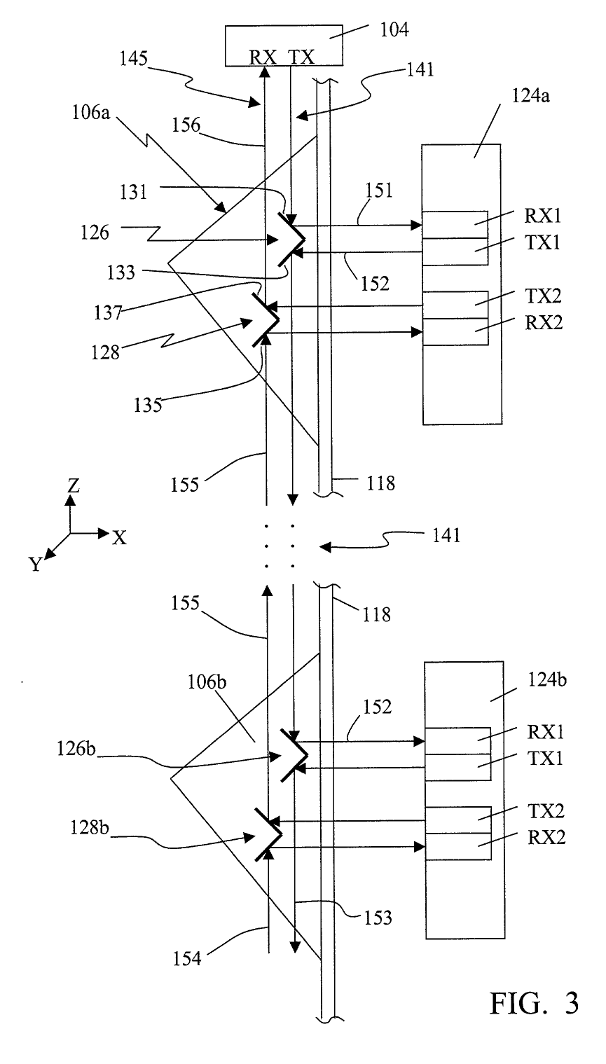

Referring to FIG. 3, there is illustrated a simplified block diagram of two PODs 106a-b, each optically coupled with a CPE transceiver 124a-b, respectively. Further, the first POD 106a is optically aligned and coupled with a rooftop transceiver 104, and the second POD 106b is optically aligned with the first POD 106a and thus coupled with the rooftop transceiver 104 through optical communication paths 141, 145. In the embodiment shown in FIG. 3, the transmit and receive paths are distinct, however, a single, collinear path can be utilized for both the transmit and receive paths. The optical transmit and receive signals may utilize substantially any wavelength. By way of example, a single wavelength signal at 850 nm may be used for a signal 151 transmitted by the rooftop transceiver 104, and a single wavelength signal at 850 nm may be used for the signal 156 received by the rooftop transceiver 104. By way of another example, wavelengths in the range of 1330 nm may be used for the transmit signal 151 and wavelengths in the range of 1500 nm may be used for the receive signal 156. The power level of the transmit and receive signals are of sufficient power to propagate to the POD 106 or to the rooftop transceiver 104 such that the signal is accurately received. By way of example, signal power for the transmitter in the rooftop transceivers 104 may be 3 mW IEC class IIIA. Further, the dynamic range for the receiver in the rooftop transceivers 104 is sufficient to accurately receive the optical signals. For example, the dynamic range for the receiver of the rooftop transceiver may be −45 to −12 dBm. It should be well understood, however, that various other specifications may be used in accordance with the present invention. The transmitter and receiver of the CPE transceiver 124 can be similarly configured; however, alternate configurations may be employed, as would be apparent to one skilled in the art.

The POD 106 is constructed to optically redirect optical signals to and from the CPE transceiver 124. Typically, the redirection of the optical signals is achieved through reflection or deflection of the signals. The PODs 106 are configured to minimize attenuation of the redirected signals. Further, the PODs 106 are constructed to minimize or prevent water beading to avoid signal distortion and minimize or prevent dust and dirt particles from settling on the surfaces of the POD 106, which can adversely affect the optical signals. The body of the PODs 106 can be made from substantially any material capable of passing optical signals including glass, plastic and other such material. In one embodiment, the body of the PODs are made of an optically transparent material that is transparent for a narrow wavelength band. Alternatively, the PODs are constructed from substantially any optically transparent material. In one embodiment, the PODs 106 are made strictly of glass. Such PODs 106 are passive components rather than active. Therefore, the MTU optical network 101 of the present invention may be referred to as an MTU “semi-PON”.

The PODs 106 can have substantially any geometric shape allowing the optical signals to be redirected by the reflective elements 126, 128 within the POD. For example, the POD can have a triangular, pyramid, hyperbolic or other shape that allows the optical signal to pass into the POD and be redirected by one or more reflective elements to be received by a CPE. The POD can also be configured to redirect the optical signal to impinge upon another POD to allow the other POD to direct the signal a CPE or yet another POD. For example, a first POD can redirect an optical signal horizontally to a second POD. For example, the second POD can be positioned on a corner of the building allowing the redirection of the signal to another side of the building and thus to other customers within the building. This can be utilized to reduce the number of rooftop transceivers needed to establish a plurality of communication paths.

Still referring to FIG. 3, each POD 106 includes one or more reflective elements 126. The reflective element 126 can be formed through air pockets (or air cavities), reflective mirrors, materials within the POD body for redirecting the optical signals, and the like. In one embodiment, the POD 106 includes one or more air pockets 126, 128 that provide reflective surfaces 131, 133, 135, and 137 upon which optical signals reflect. In one embodiment the air pockets are generally “V” shaped. Typically, a first air pocket 126 is included for redirecting signals 151 transmitted from the rooftop transceiver 104 or other optical signal initiation source. The POD 106 can include a second air pocket 128 for redirecting a signal 156 from a CPE transceiver 124 to be received by the rooftop transceiver 104. Preferably, the divergence of the beam impinging on a reflective element 126, 128 is limited such that the beam width does not exceed the width of the reflective element 126, 128. By way of example, the reflective index for the air pockets 126, 128 within the POD glass may be one (1), and each of the air pockets 126, 128 may be 4 cm wide. With a 4 cm wide reflective element 126, 128, the transmit and receive beam divergence is preferably less than 1.5 mRad such that the beam width at a range of 300 meters does not exceed the width of the air pockets 126, 128 within the POD 106 (4 cm). In some embodiments, attenuation of beams passing through and being redirected by the POD 106 is approximately 3 dB. The width of the reflective elements 126, 128 can be substantially any size. However, the width is preferably limited to avoid an excessively large POD.

In one embodiment, the POD is configured such that the first reflective element 126 is offset from the second reflective element 128. Thus, two independent optical communication paths 141 and 145 are provided. Typically, these optical communication paths 141 and 145 are substantially parallel and non-collinear. However, these communication paths do not have to be parallel. In one embodiment, the POD can include only a single reflective element such that the first and second communication paths are collinear. The offset of the two reflective elements 126 and 128 can be along a Y-axis, along an X-axis or some combination, for example, along the X and Y, X and Z, or X, Y and Z-axes.

In operation a first optical signal 151 transmitted by the rooftop transceiver 104 impinges on the first reflective surface 131 of the first reflective element 126a. The first reflective element redirects the first optical signal 151 to be received by the first CPE transceiver 124a. The first CPE transceiver 124a transmits a second optical signal 152 to impinge on the second reflective surface 133 of the first reflective element 126, which in turn redirects the second optical signal 152 to impinge on the first reflective element 126b of the second POD 106b. In one embodiment, the first CPE transceiver 124a re-transmits or reflects the first optical signal to produce the second optical signal. The second optical signal can also include data from the first optical signal and data added by the first CPE transceiver 124a. Further, the second optical signal can include data from the first optical signal excluding data intended for the first CPE transceiver 124a.

The first reflective element 126b of the second POD 106b redirects the second optical signal 152 to be received by the second CPE transceiver 124b. The second CPE transceiver can transmit a third optical signal 153 to impinge on the first reflective element 126b, which redirects the third optical signal to additional equipment, such as other PODs and CPEs if other PODs and CPEs exist in the communication paths.

The second POD 106b is further configured to receive a fourth optical signal 154 from additional equipment (not shown) and to redirect the fourth optical signal to be received by the second CPE transceiver 124b. The second CPE transceiver can additionally transmit a fifth optical signal 155 to impinge on the second surface of the second reflective element 128b of the second POD 106b. The fifth optical signal 155 can include all or part of the fourth optical signal, and may also include additional information provided by the second CPE transceiver 124b. The second reflective element 128b redirects the fifth optical signal 155 to impinge on the first reflective surface 135 of the second reflective element 128a of the first POD 106a, which in turn redirects the fifth optical signal to the first CPE transceiver 124a. The first CPE transceiver can transmit a sixth optical signal 156 to impinge on the second reflective surface 137 of the second reflective element 128a of the first POD 106a, which in turn redirects the sixth optical signal 156 to be received by the rooftop transceiver 104.

The POD 106 is typically designed to deflect the signals 90 degrees from the angle of impact, but this is not required and can be substantially any angle for alignment with the CPE 108. The POD 106 is preferably designed to provide maximal water beading to prevent dirt particles from settling on the upper surface of the external body. The POD 106 is typically mounted to the surface area of the external building window 118. However, alternative mountings can be employed as would be apparent to one skilled in the art. As an optional feature, the POD 106 may be equipped with a safety mounting cable such that the POD 106 can be attached to a mounting point on or near the window.

Still referring to FIG. 3, the CPE transceivers 124a-b may be used to receive the optical signals deflected from the PODs 106. In one embodiment, signals transmit from and receive by the CPE transceiver 124 (e.g., first and sixth optical signals 151, 156, respectively) are separate and distinct; however, the transmit and receive paths can be a single path where the signals are separated by the CPE transceiver. Transmit signals 151 from the rooftop transceiver 104 (or another CPE and POD) are deflected from the first available POD 106a into the receive port RX1 of the CPE transceiver, for example, first CPE transceiver 124a. If data carried by the optical signal 151 is addressed to the first CPE transceiver 124a, then the first CPE transceiver 124a processes the signal 151, allowing the customer access to the data. If the signal includes data that is not intended for the first CPE transceiver 124a, then the first CPE transceiver 124, routes or re-transmits the optical signal, and thus the data, back to the first POD 106a using transmit port TX1 producing the second optical signal 152. Attenuation introduced by the POD 106 is preferably compensated for by the first CPE transceiver 124a at the transmit port TX1. By way of example, the signal power for the CPE transmitters may be 3 mW class IIIA, and the dynamic range for the CPE receivers may be −45 to −12 dBm. In one embodiment, the POD and CPE equipment are co-located allowing the reduction of the size of the PODs and the transmit and receive apertures of the CPE equipment.

The CPE transceivers 124 may be either active or passive in accordance with the present invention. Active CPE transceivers 124 perform routing, while passive CPE transceivers 124 simply pass the traffic along to customer equipment. The following discussion focuses on a comparison of an active versus passive CPE transceiver 124.

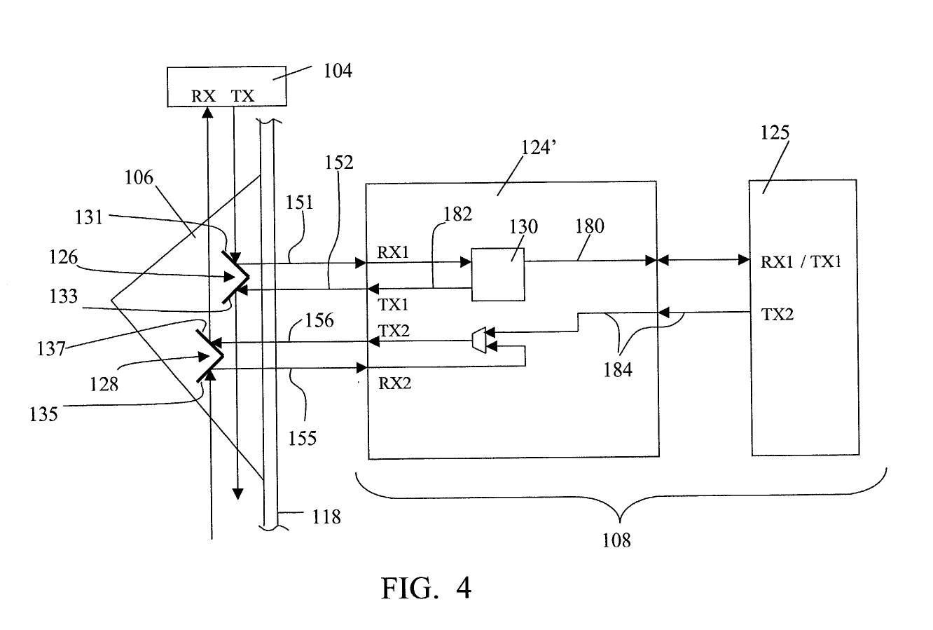

Referring to FIG. 4, there is illustrated an active CPE transceiver 124′ made in accordance with one embodiment of the present invention. The active CPE transceiver 124′ includes a router 130. The active CPE transceiver 124′ receives the first optical signal 151 from a rooftop transceiver of other CPE/POD and processes the signal by looking at the packets or cells. The active CPE 124′ determines whether or not the packets or cells are intended for its particular customer site to determine whether or not to pass along the packets. In one embodiment, the active CPE transceiver 124′ is targeted at a specific protocol or group of protocols (e.g., IP, ATM, etc.).

If the active CPE transceiver 124′ determines that the data is intended for its particular customer site, the router 130 directs a signal 180 containing the data to be forwarded to the customer equipment 125 (for example, a hub, a switch, a router, a computer, a server and other such equipment). If it is determined that the data is not intended for its particular customer site, the router 130 directs a signal 182, providing the second optical signal 152, back to the POD 106 to be forwarded to the next POD and CPE along the communication path 141 (see FIGS. 1 and 2). The optical signal 182 is re-transmitted by the CPE and impinges on the second surface 133 of the first reflective element 126 of the POD 106 and is redirected to the next POD (e.g., POD 106b, see FIG. 3) to be again redirected by the next POD into the next CPE transceiver, (e.g., second CPE transceiver 124b).

The CPE equipment 108 is further configured to allow communication of data within both the MTU network 101 and the external network 103 (see FIG. 1). The customer equipment 125 can generate a CPE transmit signal 184. The CPE transmit signal 184 is received by the active CPE transceiver 124′. The active CPE transceiver 124′ incorporates or multiplexes the CPE transmit signal 184 with signals received from other equipment (e.g., fifth optical signal 155), if present, and forwards the sixth optical signal 156, including the CPE transmit signal 184, to be reflected by the second surface 137 of the second reflective element 128 of the POD 106 back to the rooftop transceiver 104 or to a next POD.

In one embodiment, a fifth optical signal 155 received from another CPE/POD is forwarded to the router 130 to determine if the fifth signal includes data intended for the customer equipment 125. If the fifth signal 155 does include data for the CPE equipment, the router 130 routes the data to the customer equipment 125. If the fifth optical signal 155 does not include data for the CPE equipment, the router 130 redirects the fifth optical signal to be transmitted as the sixth optical signal 156 to impinge on the second reflective element 128 of the POD 106 to be redirected to the rooftop transceiver or equipment of the MTU network 101 (e.g., another POD/CPE).

Providing active routing allows the customer to use equipment that runs at a slower speed than the MTU optical network 101, which can be advantageous in crowded buildings that would require very fast networks. This ability could be extended to throttling, which allows different customers to pay for different amounts of bandwidth, which would then be regulated by, for example, the CPE transceiver 124′. The network service provider can provide in a separate component or box the routing and throttling functions. Another advantage of an active system is the ability to provide additional levels of security. For example, by utilizing the active routing, the system 101 is capable of determining which customers are entitled to receive specific data, establishing a layer of security that can be used for the establishment of Virtual Private networks between floors. Thus, an active system can provide for lower customer speeds and added network security.

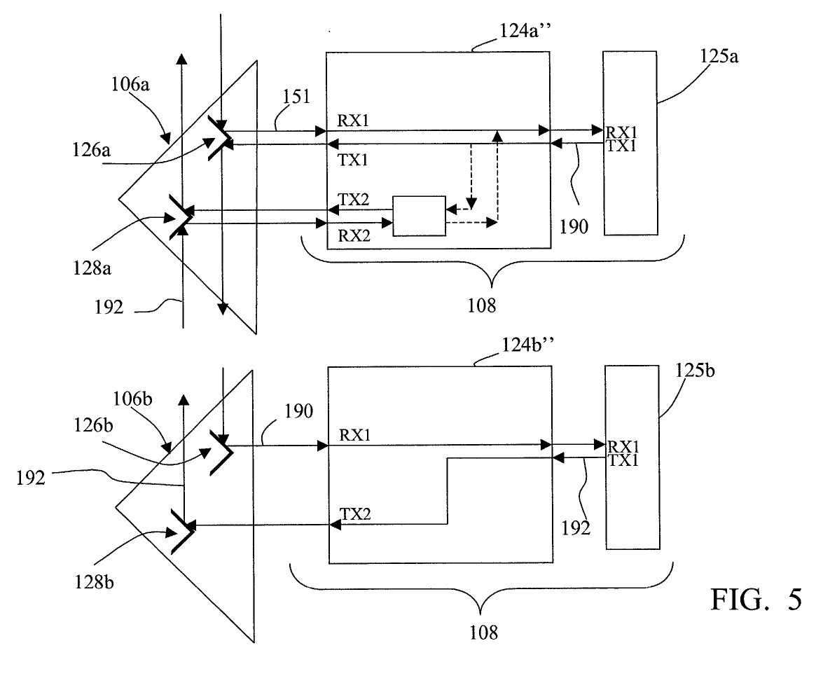

Referring to FIG. 5, there is illustrated two passive CPE transceivers 124a″ and 124b″ made in accordance with an embodiment of the present invention. Unlike their active counterparts, the passive CPE transceivers 124″ act on the physical layer leaving routing to customer equipment 125. Advantageously, a passive system allows the CPE transceiver 124″ and customer equipment 125 to be used in a wider variety of applications. For example, transceivers can be configured in one of two modes: standard or endpoint. The lowest CPE transceiver in the building along an optical communication path is configured as an endpoint CPE 124b″ and the remainder of the CPE transceivers in the optical communication path are configured as standard transceivers 124a″.

A first optical signal 151 received at a standard CPE transceiver 124a″ is passed by the CPE transceiver 124a″ to the CPE equipment 125a. In one embodiment, the CPE transceiver 124a″ forwards the signal to the standard CPE equipment 125 and re-transmits the signal without further processing. In one embodiment, the CPE equipment 125a re-transmits the signal 190 to the CPE transceiver 124a″ without waiting for further processing. The CPE transceiver 124a″ in turn transmits the signal 190 to impinge on the first reflective element 126a of the first POD 106a. The reflective element 126a reflects the signal 190 and directs the signal to impinge on the second POD 106b. The first reflective element 126b of the second POD 106b reflects the signal 190 to additional equipment, for example, the endpoint CPE transceiver 124b″. The endpoint transceiver forwards the signal 190 to the CPE equipment 125b, where the CPE equipment processes the signal and data. The endpoint CPE equipment 125b does not re-transmit the signal because the CPE equipment is the endpoint.

When the endpoint CPE equipment 125b transmits data to be communicated over the MTU network 101 and/or external network 103, the endpoint CPE equipment 125b generates and sends an endpoint data signal 192 to the endpoint CPE transceiver 124b″. The endpoint CPE transceiver optically transmits the endpoint data signal to impinge on the second reflective element 128b of the second POD 106b. The second reflective element 128b redirects the endpoint data signal 192 to be received by the rooftop transceiver 04 to impinge on a second reflective element 128a of a first POD 106a if present in the communication path.

The second reflective element 128a of the first POD 106a redirects the endpoint signal 192 to a standard CPE transceiver 124a″. In one embodiment, the standard CPE transceiver 124a″ includes a loop through 160. The loop through 160 simply receives the endpoint data signal 192 and re-transmits the signal to again impinge on the second reflective element 128a of the first POD 106a to be redirected to the next POD in the optical path or to the rooftop transceiver 104.

In one embodiment, the standard CPE transceiver 124a″ is additionally configured to route the endpoint data signal 192 to the customer equipment 125 to allow communication within the MTU network 101. The standard CPE transceiver 124a″ can additionally be configured to receive data from the CPE equipment 125a and multiplex the data from the CPE equipment 125a with the endpoint data signal 192 to be directed to the rooftop transceiver 104 or other POD and CPE equipment.

The network isolation that is provided by an active system is also possible utilizing the passive CPE transceiver 124″ if the passive CPE transceiver 124″ is used in concert with a third party router, for example, as part of the CPE equipment 125. This approach not only makes the system more flexible, but it would allow passive component manufacturers to focus on their area of expertise.

The following discussion focuses on the isolation of network and/or customer failures or faults with respect to the CPE transceivers 124. The present invention is typically implemented to prevent a malfunction at one POD or customer site from taking down an entire optical path or the entire network. Examples of three classes of malfunction can include: (1) CPE transceiver removal/misalignment; (2) CPE transceiver malfunction; and (3) CPE transceiver loss of power.

With respect to CPE transceiver removal or misalignment, some versions of the MTU optical network 101 include optical paths that rely on every node to serve as a relay. For this reason the removal or misalignment of a CPE transceiver 124 could potentially take down an optical path or potentially the network depending on network topology. Though little can be done to prevent deliberate customer removal of the CPE transceiver 124, this is highly unlikely. Additionally, because each POD along an optical path are aligned, the removal of one POD will not adversely affect the optical communication of the network 101 because the optical signal (e.g., transmit signal 151) simply continues along the path to impinge on the next POD of the path. The second possibility is accidental misalignment caused by a small earthquake, someone bumping into the equipment, or similar occurrences. This is avoided by insuring that all CPE transceivers 124 are securely mounted with the building and potentially with the PODs through a window or wall of the building. In one embodiment, the network 101 is established with alignment margins of error, whereby CPE transceivers have large receiver ports allowing some misalignment from an optimum alignment while still maintaining optical communication. Additionally, in one embodiment, the surface of the reflective element 126 or 128 reflecting the signal to be received by the CPE (e.g., first surfaces 131 and 135 of the first and second reflective elements 126 and 128, respectively) is configured to provide an increased beam divergence, thereby increasing the area of alignment with the CPE 108.

Another possible threat to the network is a fault or malfunction in one of the CPE transceivers 124. In one embodiment, this is remedied by having the CPE transceiver 124 switch into a loop through mode. This would be dependant on the ability of the CPE transceiver to detect a fault or be notified of a fault. In one embodiment, the rooftop transceiver 104 is configured to aid in fault detection. If a CPE transceiver 124 experiences a fatal fault and is itself unaware of it, the rooftop transceiver 104 detects the loss of traffic. The rooftop transceiver employs fault detection means to recognize and adjust for faults. A variety of simple algorithms, as would be understood by one skilled in the art, can be employed for the means of detecting the faulty CPE transceiver(s) 124. The rooftop transceiver 104 can then instruct the faulty CPE transceiver to go into loop through mode.

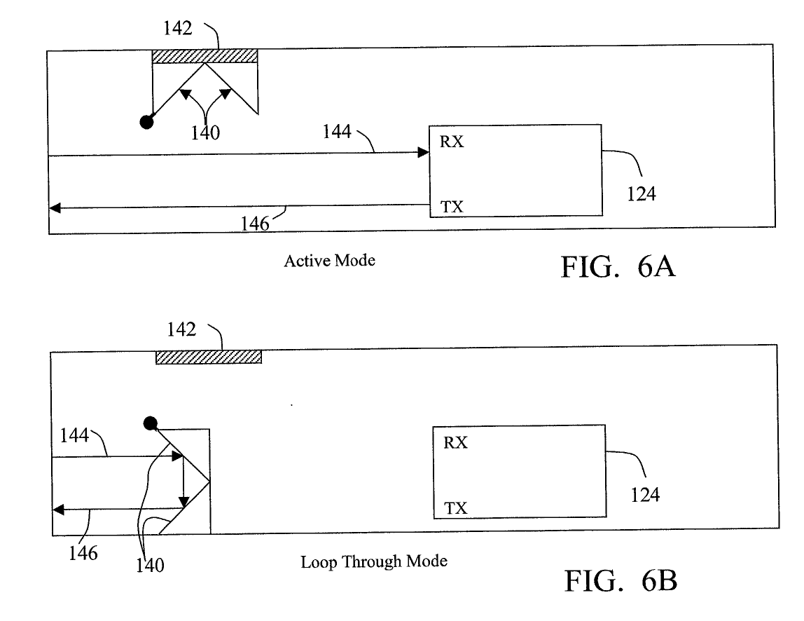

A third threat to the network is a power fault or loss of power in a CPE transceiver 124. In one embodiment, this problem is remedied with an optical passive relay. Referring to FIGS. 6A and 6B, there are illustrated simplified block diagrams of an optical passive relay (or passive optical loop-through) made in accordance with an embodiment of the present invention. This scheme uses a mirror pair 140 as a relay. Referring to FIG. 6A, in one embodiment, the mirror pair 140 is held in a first position out of the transmit and receive CPE communication paths 144 and 146, for example, by an electromagnet 142, during normal operating conditions.

Referring to FIG. 6B, during a loss of power to the CPE transceiver 124 the electromagnet 142 ceases to be magnetic and allows the mirror pair 140 to shift to a second position into the CPE communication paths 144, 146. In the second position, the mirror pair 140 serves as a beam relay to both the transmit and receive paths 144, 146, re-transmitting the transmit and receive beams 144 and 146, respectively, back to the POD 106. When power is restored to the CPE transceiver 124, the electromagnet 142 again becomes magnetic and attracts the mirror pair 140 removing the mirror pair from the communication paths. This mirror pair can also be employed as a loop through mode when the CPE transceiver is experiencing other errors or faults.

In addition to protecting against failure by loss of power, the optical passive relay 140 can also protect against failure of the transmit circuitry in the CPE transceiver 124, which is not done by an active relay system. Furthermore, the mirror pair 140 can be implemented using semi-transparent mirrors allowing the CPE transceiver 124 to continue receiving signals in loop through operation. In the case of a rooftop transceiver controlled error correction scheme, this allows the rooftop transceiver 104 to instruct the customer CPE transceiver 124 to re-attempt normal operation.

The MTU network 101 as described above is configured to operate on the exterior of a building 100. However, the MTU network 101 operates equal well through open spaces within a building 100 where communication paths can be established. For example, the rooftop transceiver can be mounted within an elevator shaft as appose to the roof where the elevator does not interfere with the optical communication path. Additionally, the PODs 106 can also be mounted within the elevator shaft in optical alignment with the rooftop transceiver mounted in the elevator shaft. The PODs 106 continue to operate as described above redirecting the optical signals to and from the CPEs 108. In one embodiment, a POD 106 can be optically aligned and coupled with a router (not shown) which routes the signal to CPEs 108. For example, one or more PODs 106 can be positioned per floor and signals redirected by the POD are processed by the router to determine if the signal is to be delivered to a CPE 108 on that floor. If the signal is to be delivered, the router routes the signal to the appropriate CPE. If not, the router re-transmits the optical signal to impinge on the POD 106 to be directed to the next POD along the optical path. The network 101 can also be incorporated within an atrium or other open space providing optical line of sight for establishing the optical communication paths between the rooftop transceivers and the PODs. As such, the phrase “exterior of the building” can be defined to include the structure of the build along an open space (e.g., along the building within an elevator shaft, and/or along the build within an atrium) allowing free-space links to be established to allow communication to and from the CPEs.

The entire content of the following United States patent is hereby fully incorporated into the present application by reference: U.S. Pat. No. 6,239,888, filed Apr. 24, 1998, entitled TERRESTRIAL OPTICAL COMMUNICATION NETWORK OF INTEGRATED FIBER AND FREE-SPACE LINKS WHICH REQUIRES NO ELECTRO-OPTICAL CONVERSION BETWEEN LINKS, by inventor Heinz Willebrand. The entire contents of the following United States patent application is hereby fully incorporated into the present application by reference: U.S. patent application Ser. No. 09/482,782, filed Jan. 13, 2000, entitled HYBRID WIRELESS OPTICAL AND RADIO FREQUENCY COMMUNICATION LINK, by inventors Heinz Willebrand and Maha Achour. By way of example, the laser link heads 108, 110 (FIG. 1), the rooftop transceivers 104, and/or any other components described herein may comprise any of the devices or methods described in the above cited United States patent and patent application.

While the invention herein disclosed has been described by means of specific embodiments and applications thereof, numerous modifications and variations could be made thereto by those skilled in the art without departing from the scope of the invention.

What is claimed is:

1. An optical communication system, comprising:
a first rooftop transceiver mounted on a building and configured to transmit and receive optical signals over free space; and
a first passive optical deflector (POD) mounted on the building and optically aligned with both the first rooftop transceiver and a first customer premise equipment (CPE), wherein the first POD is configured to receive a first optical signal from the first rooftop transceiver and redirect substantially all of the first optical signal to the first CPE providing a first optical communication path between the first rooftop transceiver and the first CPE, and wherein the first POD is configured to receive a second optical signal from the first CPE and redirect substantially all of the second optical signal to additional equipment extending the first communication path between the first CPE and the additional equipment.

2. The communication network as claimed in claim 1, wherein the additional equipment comprises a second POD optically aligned with both the first POD and a second CPE;
the first POD is configured to redirect the second optical signal to impinge on the second POD; and
the second POD is configured to redirect the first optical signal to be received by the second CPE.

3. The communication network as claimed in claim 2, wherein:
the first POD includes a first reflective element;
the first reflective element includes a first reflective surface, wherein the first optical signal impinges the first reflective surface and is redirected by the first reflective surface of the first reflective element to be received by the first CPE; and
the first reflective element includes a second reflective surface, wherein the second optical signal impinges the second reflective surface and is redirected by the second reflective surface of the first reflective element to impinge on the second POD.

4. The communication network as claimed in claim 3, wherein:
the second POD is configured to receive a third optical signal from the second CPE and redirect the third optical signal to impinge the first POD;
the first POD is configured to redirect the third optical signal from the second POD to be received by the first CPE; and
the first POD is further configured to receive a fourth optical is signal from the first CPE and redirect the fourth optical signal to be received by the first rooftop transceiver.

5. The communication network as claimed in claim 4, wherein:
the first POD includes a second reflective element;
the second reflective element includes a first reflective surface, wherein the third optical signal from the second POD impinges the first reflective surface of the second reflective element and is redirected by the first reflective surface of the second reflective element to be received by the first CPE; and
the second reflective element includes a second reflective surface, wherein the fourth optical signal received from the first CPE impinges the second reflective surface of the second reflective element and is redirected by the second reflective surface of the second reflective element to be received by the first rooftop transceiver.

6. The communication network as claimed in claim 4, further comprising:
a second rooftop transceiver mounted on the building and configured to transmit and receive optical signals over free space; and
a third POD mounted on the building and optically aligned with both the second rooftop transceiver and a third CPE, wherein the third POD is configured to receive a fifth optical signal from the second rooftop transceiver and redirect substantially all of the fifth optical signal to the third CPE providing a second optical communication path between the second rooftop transceiver and the third CPE.

7. The communication network as claimed in claim 6, further comprising:
a fourth POD optically aligned with both the third POD and a fourth CPE;
the third POD is configured to receive a sixth optical signal from the third CPE and redirect the sixth optical signal to impinge on the fourth POD; and
the fourth POD is configured to redirect the sixth optical signal to be received by the fourth CPE.

8. The communication network as claimed in claim 2, wherein:
the first CPE is configured to generate and transmit a seventh optical signal, wherein the seventh optical signal impinges the first POD; and
the first POD is configured to redirect the seventh optical signal from the first CPE to be received by the first rooftop transceiver.

9. The communication network as claimed in claim 1, wherein:
the first CPE includes first and second CPE communication paths and a first mirror pair, wherein the first mirror pair is maintained in a first position outside of the first and second CPE communication paths while the CPE operates under normal conditions; and
the first mirror pair is configured to be positioned in a second position within the first and second CPE communication paths such that optical signals received along the first CPE communication path are at least in part redirected along the second CPE communication path when a fault occurs with the first CPE.

10. The communication network as claimed in claim 9, wherein:
the first mirror pair is configured to allow at least a portion of the optical signals received along the first CPE communication path to pass through the first mirror pair to be received by the first CPE when the fault occurs with the first CPE.

11. The communication network as claimed in claim 1, further comprising:
a customer distribution unit (CDU) communicationally coupled with the first rooftop transceiver, wherein the CDU is configured to communicate data to and from the first rooftop transceiver; and
a link head transceiver is coupled with the CDU, wherein the link head transceiver is configured to communicate with an external network such that the first CPE receives data from the external network through the link head transceiver and communicates data to the external network through the link head transceiver.

12. The communication network as claimed in claim 1, further comprising:
a second POD optically aligned with both the first POD and a second CPE;
the first CPE is configured to receive the first optical signal and determine if the first optical signal is intended for the first CPE and to transmit the second optical signal based on the first optical signal to impinge on the first POD if the first optical signal is not intended for the first CPE;
the first POD is configured to redirect the second optical signal from the first CPE to impinge on the second POD; and
the second POD is configured to redirect the second optical signal to be received by the second CPE.

13. A method for providing communication, comprising the steps of:
generating a first optical communication signal and transmitting the first optical signal over free space along an exterior of a building;
redirecting the first optical signal to be received by a first customer premise equipment (CPE);
the first CPE receiving the first optical signal;
the first CPE re-transmitting a least a portion of the first optical signal;
redirecting for a first instance the first optical signal re-transmitted by the first CPE;
redirecting for a second instance the first optical signal re-transmitted by the first CPE to be received by a second CPE; and
the second CPE receiving the first optical signal.

14. The method as claimed in claim 13, further comprising the steps of:
the first CPE determining if data carried by the first optical signal is intended for the first CPE; and
the step of the first CPE re-transmitting at least a portion of the first optical signal including re-transmitting the first optical signal if the data is not intended for the first CPE.

15. The method as claimed in claim 14, further comprising the steps of:
the second CPE generating and transmitting a second optical signal;
redirecting for a first instance the second optical signal transmitted from the second CPE over free space along the exterior of the building;
redirecting for a second instance the second optical signal to be received by the first CPE;
the first CPE receiving the second optical signal;
the first CPE re-transmitting the second optical signal; and
redirecting the second optical signal transmitted from the first CPE to be received by a rooftop transceiver.

16. The method as claimed in claim 15, further comprising the steps of:
receiving a first communication signal from an external network;
the step of generating the first optical signal including generating the first optical signal based on the first communication signal;
generating a second communication signal based on the second optical signal received by the first rooftop transceiver; and
communicating the second communication signal with the external communication network.

17. An optical communication system, comprising:
first premise equipment means for receiving and transmitting optical signals;
second premise equipment means for receiving and transmitting optical signals;
optical signal initiation means for transmitting a first optical signal across free space along an exterior of a building;
first redirecting means for receiving the first optical signal from the optical signal initiation means and for redirecting substantially all of the first optical signal to the first premise equipment means;
second redirecting means for receiving a second optical signal from the first premise equipment means and for redirecting substantially all of the second optical signal over free space along the exterior of the building; and
third redirecting means for receiving the second optical signal from the second redirecting means and for redirecting substantially all of the second optical signal to the second premise equipment means.

18. The system as claimed in claim 17, wherein:
fourth redirecting means for receiving a third optical signal from the second redirecting means and for redirecting substantially all of the third optical signal along the exterior of the building;
fifth redirecting means for receiving the third optical signal from the fourth redirecting means and for redirecting substantially all of the fourth optical signal to the first premise equipment means; and
sixth redirecting means for receiving a fifth optical signal from the first premise equipment means and for redirecting substantially all of the fifth optical signal to the optical signal initiation means.

19. The system as claimed in claim 18, wherein:
the first premise equipment means includes a means for reflecting at least a portion of the first optical signal if a fault occurs with the first premise equipment means providing the second optical signal to impinge on the second means for redirecting.

20. The system as claimed in claim 17, wherein:
the first premise equipment means is configured to determine if the first optical signal includes data intended for the first premise equipment means and to generate the second optical signal based at least in part on the first optical signal if the first optical signal includes data not intended for the first premise equipment means.

21. An apparatus for directing optical signals, comprising:
a body of optically transparent material;
the body includes a first reflective element, wherein the first reflective element includes a first reflective surface and a second reflective surface; and
the body includes a second reflective element, wherein the second reflective element includes a first reflective surface and a second reflective surface.

22. The apparatus as claimed in claim 21, wherein the first and second reflective elements are situated in the body so that a first optical signal reflected by the first reflective surface of the first reflective element and a second optical signal reflected by the second reflective surface of the second reflective element are substantially parallel.

23. The apparatus as claimed in claim 22, wherein the first optical signal reflected by the first reflective surface of the first reflective element and the second optical signal reflected by the second reflective surface of the second reflective element are not collinear.

24. The apparatus as claimed in claim 22, wherein the first and second reflective elements are situated in the body so that a third optical signal reflected by the second reflective surface of the first reflective element and a fourth optical signal reflected by the first reflective surface of the second reflective element are substantially parallel.

25. The apparatus as claimed in claim 21, wherein the first reflective element is formed from an air pocket within the body.

26. The apparatus as claimed in claim 21, wherein the body includes an upper surface configured to minimize water beading.
